(19) United States
(12) Patent Application Publication
(10) Pub. No.: US 2026/0074985 A1
(43) Pub. Date: Mar. 12, 2026

(54) Handling CPU-Bound Packets in Multi-Chassis Systems During Hitless Reboot

(71) Applicant: Arista Networks, Inc., Santa Clara, CA (US)

(72) Inventors: Akhil SHASHIDHAR, Austin, TX (US); Anand NARAYANAN, Austin, TX (US); Pavan NARASIMHAPRASAD, Cedar Park, TX (US); Qing YANG, Cupertino, CA (US)

(21) Appl. No.: 18/883,160

(22) Filed: Sep. 12, 2024

(51) Int. Cl. H04L 45/24; H04L 45/44; H04L 45/745; H04L 61/103

(52) U.S. Cl. CPC H04L 45/245; H04L 45/44; H04L 45/745; H04L 61/103

(57) ABSTRACT

In one set of embodiments, at the time the control plane of a peer in a multi-chassis system is shut down as part of a hitless reboot, the peer can identify one or more rules programmed in its data plane that (1) are configured on an ingress interface of a multi-chassis link aggregation group (MLAG) to which the peer is connected, and (2) specify a central processing unit (CPU) of the peer as a destination for matched network traffic. The peer can then change each identified rule to specify an inter-chassis link between the peer and another peer in the multi-chassis system, rather than the CPU of the peer, as the destination for matched network traffic.

### BACKGROUND

A hitless reboot of a network device is a procedure that involves restarting the network device's control plane while keeping its data plane operational. This allows the network device to be upgraded with a new software image, or rebooted into the same software image, without interrupting the flow of network traffic through the device.

A multi-chassis system is a collection of physical network devices, referred to as peers, that operate as a single logical network device and are configured with one or more multi-chassis link aggregation groups (MLAGs). An MLAG is a group of physical links that connect each peer in the multi-chassis system to another device (e.g., a host, another network device, etc.) and are treated as a single logical link.

When a hitless reboot is performed on a multi-chassis system, typically only one of the peers in the system, referred to as the restarting peer, will undergo the hitless reboot process while the other peers remain fully operational (which means both their control and data planes function as normal). Because the control plane of the restarting peer is mostly down during the hitless reboot, the restarting peer cannot handle network packets that require control plane processing. This can cause problems in certain scenarios, such as a scenario in which the restarting peer receives, from a device that is connected to the multi-chassis system via an MLAG, an Address Resolution Protocol (ARP) refresh reply that is intended for another peer.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example multi-chassis system in accordance with certain embodiments of the present disclosure.

FIG. 2 depicts a peer of the multi-chassis system of FIG. 1 in accordance with certain embodiments of the present disclosure.

FIG. 3 depicts an ARP refresh scenario in accordance with certain embodiments of the present disclosure.

FIG. 4 depicts an enhanced version of the peer of FIG. 2 in accordance with certain embodiments of the present disclosure.

FIG. 5 depicts a shutdown processing workflow that may be performed by the peer of FIG. 4 in accordance with certain embodiments of the present disclosure.

FIG. 6 depicts a bootup processing workflow that may be performed by the peer of FIG. 4 in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Certain embodiments of the present disclosure are directed to techniques for handling CPU-bound packets, such as ARP refresh replies, in a multi-chassis system that is undergoing a hitless reboot. As explained in further detail below, these techniques ensure that CPU-bound packets which are received by a restarting peer of the system over an MLAG (while the restarting peer's control plane is down) are forwarded to another, fully operational peer for processing.

### 1. Example Multi-Chassis System

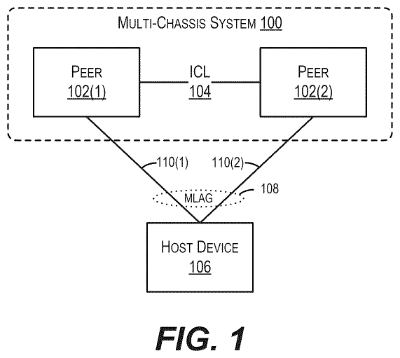

FIG. 1 is a simplified block diagram of an example multi-chassis system 100 in which the techniques of the present disclosure may be implemented. Multi-chassis system 100 is depicted as including two peers 102(1) and 102(2) for purposes of illustration, but in alternative embodiments system 100 may include more than two peers. Each peer 102 is a physical network device, such as a switch or router, that is capable of processing and forwarding network traffic.

As shown, peers 102(1) and 102(2) are communicatively coupled with each other via a direct connection, referred to as an inter-chassis link (ICL), 104. The peers use ICL 104 for various functions (e.g., data synchronization, traffic forwarding, etc.) that enable the peers to operate as a single logical entity. Peers 102(1) and 102(2) are also communicatively coupled with a host device 106 via an MLAG 108 comprising two physical links: a first link 110(1) interconnecting peer 102(1) and host device 106 and a second link 110(2) interconnecting peer 102(2) and host device 106. MLAG 108 allows the network traffic exchanged between host device 106 and multi-chassis system 100 to be distributed across links 110(1) and 110(2), thereby providing redundancy and load balancing.

From the perspective of host device 106, multi-chassis system 100 appears as a single network device with a single (virtual) Media Access Control (MAC) address and/or a single (virtual) Internet Protocol (IP) address. When host device 106 needs to send a network packet to multi-chassis system 100, the host device sets the packet's destination MAC or IP address to the system's virtual MAC or IP address (depending on whether the packet is a Layer 2 (L2) or Layer 3 (L3) packet) and applies a hash function to certain fields in the packet header to compute a hash value. Host device 106 then uses the computed hash value to select one of links 110(1) and 110(2) of MLAG 108 and sends out the packet on the selected link.

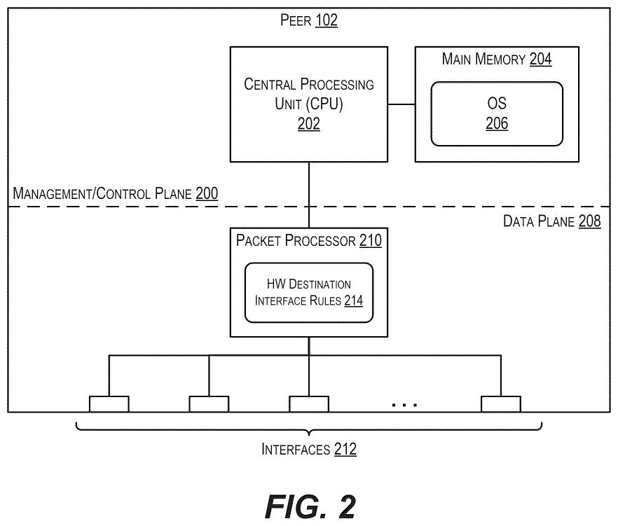

FIG. 2 is a simplified block diagram of each peer 102 of multi-chassis system 100 according to certain embodiments. As shown in FIG. 2, peer 102 includes a management/control plane 200 comprising a central processing unit (CPU) 202 and a main memory 204. CPU 202 is a general-purpose processor that is responsible for managing the configuration/operation of peer 102 and controlling the device's understanding of the network in which it resides. CPU 202 carries out these functions under the direction of an operating system (OS) 206 that runs on CPU 202 from main memory 204.

In addition, peer 102 includes a data (or forwarding) plane 208 comprising a packet processor 210 and a set of interfaces (ports) 212. Interfaces 212 include, for example, an interface that connects peer 102 to its corresponding link 110 in MLAG 108 and an interface that connects peer 102 to ICL 104. Packet processor 210 is typically a specialized processor, such as an application-specific integrated circuit (ASIC) or a field-programmable gate array (FPGA), that is responsible for performing line-speed processing of network traffic that passes through peer 102 via interfaces 212. This line-speed processing can include, for example, L2 forwarding of MAC traffic and L3 routing of IP traffic.

If packet processor 210 receives a packet that it knows how to handle (such as, e.g., a packet that simply needs to be sent to a next hop specified in a forwarding/routing table), packet processor 210 will process the packet without any intervention by control plane 200/CPU 202. On the other hand, if packet processor 210 receives a packet that it does not know how to handle (such as, e.g., a control plane protocol packet destined for the virtual MAC/IP address of multi-chassis system 100 or a packet with an expired time-to-live (TTL) value), packet processor 210 will forward (i.e., trap) the packet to CPU 202 for handling. The rules that govern which packets can and cannot be handled by packet processor 210 (and thus, which packets should be trapped to CPU 202) are shown in FIG. 2 as hardware destination interface rules 214. These rules are programmed into packet processor 210 by OS 206 via CPU 202. A hardware destination interface rule for a packet type that should be trapped to CPU 202 will include one or more match criteria matching that packet type and a destination interface specifying CPU 202 (or some hardware element associated with CPU 202, such as a CPU queue) as the internal hardware destination for packets that match the rule.

As noted in the Background section, when a hitless reboot is performed on a multi-chassis system like system 100 of FIG. 1, one of the peers (i.e., the restarting peer) will undergo the hitless reboot while the other peers remain fully operational. Because the control plane of the restarting peer is mostly down during the reboot process, the restarting peer cannot accept or respond to network packets that require control plane processing, such as ARP request or reply packets. This can be problematic in the context of ARP refreshes, which is explained below.

### 1.1 ARP Requests/Replies and ARP Refreshes

An ARP request is a packet that is sent out by a requestor R in order to learn the MAC address of a target T, given T's IP address. ARP requests are typically transmitted as L2 broadcasts over the bridging domain. When the ARP request reaches target T, the target determines that it is the owner of the IP address included in the ARP request and transmits an ARP reply packet to requestor R that includes T's MAC address. Requestor R then stores the MAC-IP address pair for target T in an entry in a local ARP cache, thereby enabling R to directly communicate with T using T's MAC address.

In many networks, devices can be added, removed, and/or reassigned IP addresses dynamically. This can cause the MAC-IP address pair for target T that is learned by requestor R via the process above to go stale (or in other words, become outdated/incorrect) after some time, which can lead to communication failures. To address this, requestor R will periodically initiate an ARP refresh process that involves sending a unicast ARP request (known as an ARP refresh request) to the MAC address of target T. In response to receiving the ARP refresh request, target T will return an ARP reply (known as an ARP refresh reply) that includes its latest IP address, thereby enabling requestor R to update its ARP cache with refreshed MAC-IP address information for T.

With the foregoing in mind, assume requestor R is peer 102(1) of multi-chassis system 100 and target T is host device 106. Because host device 106 is connected to multi-chassis system 100 via MLAG 108, it is possible for host device 106 to respond to an ARP refresh request originating from peer 102(1) by sending an ARP refresh reply to peer 102(2) via link 110(2), rather than to peer 102(1) via link 110(1) (due to the MLAG hashing mechanism mentioned previously).

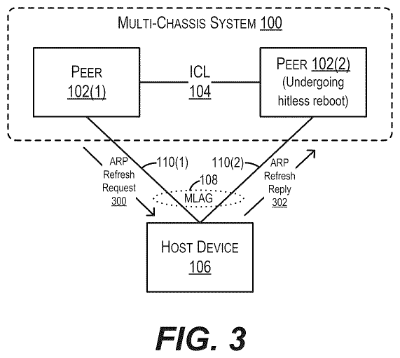

As long as the control plane on peer 102(2) is operational, there are existing mechanisms in place that enable peer 102(2)'s control plane to realize that it did not originate the ARP refresh request and thus inform peer 102(1) over ICL 104 that it received the ARP refresh reply from host device 106. However, consider the scenario shown in FIG. 3 where in response to the ARP refresh request sent by peer 102(1) (reference numeral 300), host device 106 sends out the ARP refresh reply to peer 102(2) (reference numeral 302) while peer 102(2) is in the middle of a hitless reboot. In this scenario, because peer 102(2)'s control plane is down, it will be unable to inform peer 102(1) of the ARP refresh reply. This in turn can cause the entry for host device 106 in the ARP cache of peer 102(1) to expire (in accordance with an associated timeout value), leading to problematic downstream effects such as Ethernet Virtual Private Network (EVPN) route withdrawals for T.

One workaround for this problem is for a user or administrator of multi-chassis system 100 to extend the timeout values for the entries in peer 102(1)'s ARP cache immediately prior to the hitless reboot of peer 102(2). This will prevent peer 102(1) from sending out ARP refresh requests, and thus prevent peer 102(2) from possibly receiving ARP refresh replies in response to those requests over MLAG 108, while the control plane of peer 102(2) is being rebooted. However, this workaround is cumbersome as it requires manual intervention by the system user/administrator to both extend the timeout values prior to the hitless reboot and to revert the timeout values to their original values after the hitless reboot. Further, in some implementations the modification of these timeout values may require an immediate ARP refresh to occur with respect to each modified entry, which is undesirable.

### 2. Solution Overview

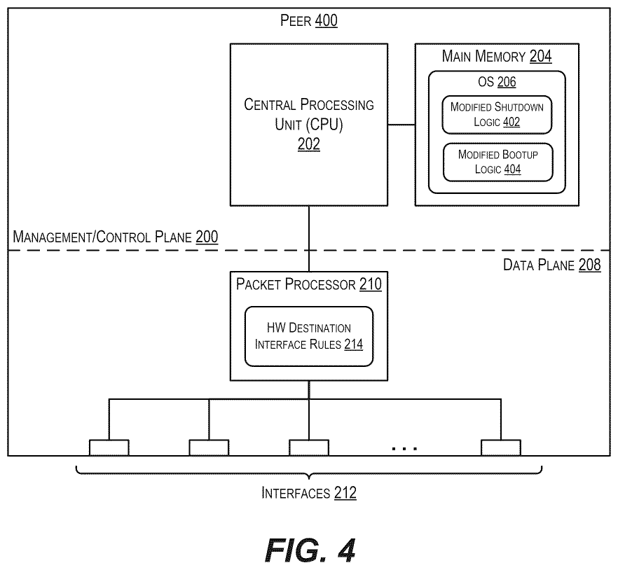

To address the foregoing and other similar problems, FIG. 4 depicts an enhanced version 400 of peer 102 of FIG. 2 according to certain embodiments. As shown, peer 400 includes modified shutdown and bootup processing logic components 402 and 404 within OS 206. In one set of embodiments, logic components 402 and 404 comprise program code that is executable by CPU 202 of peer 400.

At a high level, modified shutdown and bootup processing logic components 402 and 404 enable peer 400 to, at the time of having its control plane restarted due to a hitless reboot or some other procedure, automatically redirect certain types of incoming packets (e.g., packets that are received on an ingress interface of MLAG 108 and require control plane processing) from peer 400's CPU to another, fully functional peer. This is achieved via two workflows: (1) a first workflow implemented by modified shutdown processing logic component 402 that is executed when peer 400's control plane is shut down as part of the hitless reboot and that involves re-programming certain existing hardware destination interface rules 214 in peer 400's packet processor 210 which match on criteria identifying those packet types and which point to the CPU to instead point to another peer (or more specifically, to ICL 104); and (2) a second workflow implemented by modified bootup processing logic component 404 that is executed when peer 400's control plane is brought back up as part of the hitless reboot and that involves reverting the hardware destination interface rule changes made using the first workflow.

With this approach, ARP refresh replies and other similar CPU-bound packets that are received at peer 400 over an MLAG while its control plane is offline will be redirected to another, fully operational peer in multi-chassis system 100, thereby allowing the packets to be processed by the control plane of that other peer. For example, in the scenario shown in FIG. 3 where peer 102(2) receives, while undergoing a hitless reboot, an ARP refresh reply from host device 106 on MLAG 108 that is intended for peer 102(1), the data plane/packet processor of peer 102(2) will automatically forward the ARP refresh reply over ICL 104 to peer 102(1).

Further, packets that are received by peer 400 while its control plane is offline but can be handled at the data plane level (e.g., routed packets) will continue to be processed as normal in peer 400's data plane and thus will not be unnecessarily forwarded to another peer.

It should be appreciated that FIGS. 1-4 and the foregoing sections are illustrative and not intended to limit embodiments of the present disclosure. For example, although the foregoing sections focus on the scenario of a hitless reboot, the techniques of the present disclosure can be applied to any scenario in which the control plane of one of the peers of a multi-chassis system goes down while its data plane remains operational (and while the other peers remain fully operational).

Further, although the foregoing sections specifically discuss ARP refresh replies, this is simply one type of CPU-bound packet that can be redirected from the restarting peer to another peer. The techniques of the present disclosure may also be used to redirect other types of CPU-bound packets to the extent that such redirection is useful, such as other types of control plane protocol packets that provide certain services to hosts (e.g., Network Time Protocol (NTP) packets, etc.).

### 3. Shutdown Processing

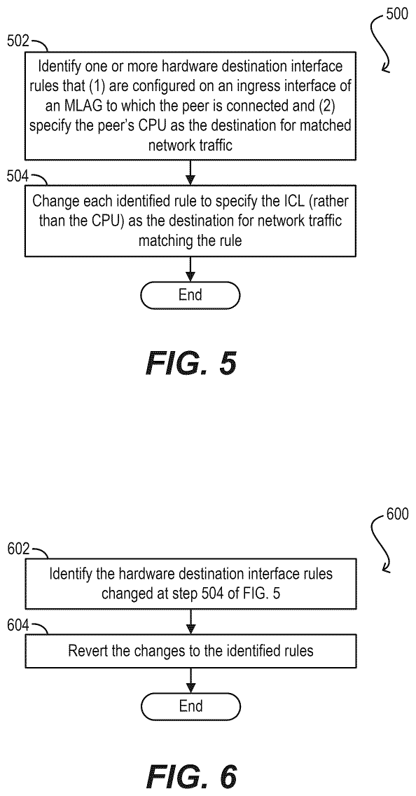

FIG. 5 depicts a workflow 500 of the modified shutdown processing that may be executed by peer 400 of FIG. 4 (or more precisely, by a process of its OS 206) in accordance with modified shutdown processing logic component 402 per certain embodiments. In one set of embodiments, peer 400 can carry out the steps of workflow 500 in response to receiving a hitless reboot request/command from a user/administrator or from an automated agent.

Starting with step 502, peer 400 can identify one or more of its hardware destination interface rules 214 that (1) are configured on an ingress interface of an MLAG to which peer 400 is connected, such as MLAG 108 of FIG. 1, and (2) specify peer 400's CPU as the destination interface for matched network traffic. There will typically be at least one such hardware destination interface rule that is designed to match ARP refresh replies, where the rule includes match criteria of destination MAC address (DMAC)==virtual MAC address (VMAC) (of multi-chassis system 100) and packet type==ARP. In some embodiments, the hardware destination interface rules identified at step 502 can be restricted to rules that include these ARP-specific match criteria (in addition to conditions (1) and (2) above).

Peer 400 can then change, or in other words re-program, each hardware destination interface rule identified at step 502 such that the destination interface of the rule points to an interface of peer 400 that is connected to ICL 104, rather than to the CPU (step 504). For example, assume the following hardware destination interface rules are programmed into the peer's packet processor 210. In this example, only interface ETH1 is an interface connecting peer 400 to an MLAG; ETH2 is a non-MLAG interface. Note that these rules are illustrative and may be formatted differently and/or include additional or different fields on different vendor implementations of peer 400/packet processor 210.

TABLE 1

| | Ingress interface | | Destination |
|---|---|---|---|
| | on which rule | | interface for |
| Rule | is configured | Match criteria | matched traffic |
| R1 | ETH1 | DMAC == VMAC && | CPU |
| | | packet type == ARP | |
| R2 | ETH1 | DMAC == VMAC && | CPU |
| | | packet type == NTP | |
| R3 | ETH2 | DIP == VIP | CPU |

Given these rules, workflow 500 will cause peer 400 to re-program the rules as shown below to change the destination interface for R1 and R2 from “CPU” to “ICL” (which refers to the interface connected to ICL 104), because R1 and R2 fulfill the conditions (1) and (2) noted at step 502.

TABLE 2

| | Ingress interface | | Destination |
|---|---|---|---|
| | on which rule | | interface for |
| Rule | is configured | Match criteria | matched traffic |
| R1 | ETH1 | DMAC == VMAC && | ICL |
| | | packet type == ARP | |
| R2 | ETH1 | DMAC == VMAC && | ICL |
| | | packet type == NTP | |
| R3 | ETH2 | DIP == VIP | CPU |

### 4. Bootup Processing

FIG. 6 depicts a workflow 600 of the modified bootup processing that may be executed by peer 400 of FIG. 4 (or more precisely, by a process of its OS 206) in accordance with modified bootup processing logic component 404 per certain embodiments. In one set of embodiments, peer 400 can carry out the steps of workflow 600 at the time its control plane is restarted as part of a hitless reboot.

Starting with step 602, peer 400 can identify the hardware destination interface rules that it modified prior to the reboot via shutdown processing workflow 500. This step can involve finding all hardware destination interface rules 214 that (1) are configured on an ingress interface of an MLAG to which peer 400 is connected, such as MLAG 108 of FIG. 1, and (2) specify the interface of peer 400 that is connected to ICL 104 as the destination interface for matched network traffic. Alternatively, this step can involve finding all hardware destination interface rules 214 that meet conditions (1) and (2) as well as include match criteria of DMAC==VMAC and packet type==ARP.

Peer 400 can then change each hardware destination interface rule identified at step 602 to revert the changes made to those rules during workflow 500, or in other words change the destination interface of each identified rule to once again point to peer 400's CPU rather than to the interface connected to ICL 104 (step 604). For instance, with respect to example rules R1-R3 in the preceding section, workflow 600 can cause peer 400 to revert rules R1 and R2 from the state shown in Table 2 to the state shown in Table 1.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a peer in a plurality of peers comprising a multi-chassis system, the method comprising, at a time of shutting down a control plane of the peer for a hitless reboot:
identifying one or more rules programmed in a data plane of the peer that:
are configured on an ingress interface of a multi-chassis link aggregation group (MLAG) to which the peer is connected; and
specify a central processing unit (CPU) of the peer as a destination for matched network traffic; and
for each of the identified rules, changing the rule to specify an inter-chassis link between the peer and another peer in the plurality of peers as the destination for matched network traffic.

2. The method of claim 1 wherein the identified rules further include a match field of source Media Access Control (MAC) address and a match value corresponding to a virtual MAC address of the multi-chassis system.

3. The method of claim 1 wherein the identified rules further include a match field of packet type and a match value indicative of Address Resolution Protocol (ARP).

4. The method of claim 1 wherein while the control plane of the peer is down during the hitless reboot, the data plane of the peer:
receives a network packet matching one of the identified rules; and
sends the network packet out on the inter-chassis link to said another peer, without sending the network packet to the CPU of the peer.

5. The method of claim 4 wherein the network packet is a control plane protocol packet.

6. The method of claim 5 wherein the network packet is an ARP refresh reply.

7. The method of claim 6 wherein the ARP refresh reply was sent by a device communicatively coupled with the multi-chassis system via the MLAG.

8. The method of claim 7 wherein the ARP refresh reply was sent by the device in response to an ARP refresh request originating from said another peer.

9. The method of claim 1 further comprising, at a time the control plane of the peer is booted up as part of the hitless reboot:
reverting the identified rules to once again specify the CPU of the peer as the destination of matched network traffic.

10. A network device that is part of a multi-chassis system comprising a plurality of network devices, the network device comprising:
a data plane; and
a control plane including a central processing unit (CPU) and a main memory, the main memory having stored thereon program code that when executed by the CPU causes the CPU to, at a time of shutting down the control plane for a hitless reboot:
identify one or more rules programmed in the data plane that:
are configured on an ingress interface of a multi-chassis link aggregation group (MLAG) to which the network device is connected; and
specify the CPU as a destination for matched network traffic; and
for each of the identified rules, change the rule to specify an inter-chassis link between the network device and another network device in the plurality of network devices as the destination for matched network traffic.

11. The network device of claim 10 wherein the identified rules further include a match field of source Media Access Control (MAC) address and a match value corresponding to a virtual MAC address of the multi-chassis system.

12. The network device of claim 10 wherein the identified rules further include a match field of packet type and a match value indicative of Address Resolution Protocol (ARP).

13. The network device of claim 10 wherein while the control plane is down during the hitless reboot, the data plane:
receives a network packet matching one of the identified rules; and
sends the network packet out on the inter-chassis link to said another network device, without sending the network packet to the CPU.

14. The network device of claim 13 the network packet is a control plane protocol packet.

15. The network device of claim 14 wherein the network packet is an ARP refresh reply.

16. The network device of claim 15 wherein the ARP refresh reply was sent by a device communicatively coupled with the multi-chassis system via the MLAG.

17. The network device of claim 16 wherein the ARP refresh reply was sent by the device in response to an ARP refresh request originating from said another network device.

18. The network device of claim 10 wherein the program code further causes the CPU to, at a time the control plane is booted up as part of the hitless reboot:
revert the identified rules to once again specify the CPU as the destination of matched network traffic.

19. A method performed by a peer in a plurality of peers comprising a multi-chassis system, the method comprising, at a time of shutting down a control plane of the peer:
identifying one or more rules that:
are configured on an interface of a multi-chassis link aggregation group (MLAG) which the peer is a part of; and
specify a central processing unit (CPU) of the peer as a destination for matched network traffic; and
for each of the identified rules, changing the rule to forward network traffic matching the rule to another peer in the plurality of peers rather than to the CPU.

20. The method of claim 19 wherein the control plane of the peer is shut down as part of a hitless reboot process.
